(19) United States
(12) Patent Application Publication
(10) Pub. No.: US 2023/0368081 A1
(43) Pub. Date: Nov. 16, 2023

(54) REBOOKING OPTIMIZATION FOR TRANSPORTATION DISRUPTION

(71) Applicant: INTERNATIONAL BUSINESS MACHINES CORPORATION, ARMONK, NY (US)

(72) Inventors: Markus Ettl, Yorktown Heights, NY (US); KEVIN HASKINS, Sheboygan, WI (US); Shivaram Subramanian, Frisco, TX (US)

(21) Appl. No.: 17/663,220

(22) Filed: May 13, 2022

(51) Int. Cl. G06Q 10/02; G06Q 50/30; G06Q 30/02

(52) U.S. Cl. CPC G06Q 10/02; G06Q 50/30; G06Q 30/0202

(57) ABSTRACT

A method, a computer program product, and a system for optimized passenger rebooking including obtaining at least one travel disruption affecting at least one scheduled trip for a plurality of transported items. A demand valuation is calculated for each transported item of the plurality of transported items. A plurality of supply valuations is calculated for a plurality of alternative trips. An optimized alternative trip is selected from among the plurality of alternative trips for each transported item based on a comparison of the demand valuation and the plurality of supply valuations.

### BACKGROUND

Exemplary embodiments of the present inventive concept relate to rebooking optimization, and more particularly, to rebooking optimization for transportation disruption.

Transport providers (e.g., airlines, rail, shipping, etc.) periodically encounter network disruptions wherein an event impacting a portion of the network will disrupt scheduled operations across the network resulting in delays and cancelations. In the case of airlines, network disruptions may be caused by a multitude of factors, such as weather conditions (e.g., a major storm), technology outages, air traffic control/security issues, lack of employee coverage, etc. A network disruption may unfold over a period of hours to days, during which time the airline will manage a recovery schedule of airport facilities, aircraft, and crew with the goal of returning to the steady-state network schedule operations rapidly and safely. Throughout the network disruption, flight delays and cancelations will result in disrupted passenger trips, generating a queue of passengers in need of rebooking. The recovery schedule presents options for passenger rebooking. Airlines commonly use a combination of systems and processes to rebook disrupted passengers. These systems and processes are generally reactionary, e.g., as a flight is cancelled the passengers are placed in the recovery queue. They are also generally guided by static business rules for processing passengers in the disruption queue, e.g., elite tier frequent fliers will be rebooked first. If a goal of network disruption passenger recovery is to provide each disrupted passenger with the best recovery option available, existing systems/processes are inherently inefficient. They are reactionary in that they generally only commence upon flight cancelation or delay and the business-rule approach offers limited ability to drive passenger recovery actions that achieve optimal results across complex passenger scenarios and recovery options. Passenger recovery in a network disruption event presents a significant challenge to the airline in terms of costs for service staff and passenger disruption accommodations. Furthermore, customers may have a negative service recovery experience. Although travel customers understand that network disruptions are often beyond an airline's control, they still frequently hold the airline responsible for how well they respond to the disruption. Excellence in disruption recovery can be a major factor in brand affiliation and net profits.

### SUMMARY

Exemplary embodiments of the present inventive concept relate to a method, a computer program product, and a system for optimized passenger rebooking.

According to an exemplary embodiment of the present inventive concept, a method may be provided for optimized passenger rebooking including obtaining at least one travel disruption affecting at least one scheduled trip for a plurality of transported items. A demand valuation is calculated for each transported item of the plurality of transported items. A plurality of supply valuations is calculated for a plurality of alternative trips. An optimized alternative trip is selected from among the plurality of alternative trips for each transported item based on a comparison of the demand valuation and the plurality of supply valuations.

According to an exemplary embodiment of the present inventive concept, a computer program product may be provided for optimized passenger rebooking. The computer program product includes one or more non-transitory computer-readable storage media and program instructions stored on the one or more non-transitory computer-readable storage media capable of performing a method. The method includes obtaining at least one travel disruption affecting at least one scheduled trip for a plurality of transported items. A demand valuation is calculated for each transported item of the plurality of transported items. A plurality of supply valuations is calculated for a plurality of alternative trips. An optimized alternative trip is selected from among the plurality of alternative trips for each transported item based on a comparison of the demand valuation and the plurality of supply valuations.

According to an exemplary embodiment of the present inventive concept, a computer system may be used to provide optimized passenger rebooking. The system includes one or more computer processors, one or more computer-readable storage media, and program instructions stored on the one or more of the computer-readable storage media for execution by at least one of the one or more processors capable of performing a method. The method includes obtaining at least one travel disruption affecting at least one scheduled trip for a plurality of transported items. A demand valuation is calculated for each transported item of the plurality of transported items. A plurality of supply valuations is calculated for a plurality of alternative trips. An optimized alternative trip is selected from among the plurality of alternative trips for each transported item based on a comparison of the demand valuation and the plurality of supply valuations.

### BRIEF DESCRIPTION OF THE DRAWINGS

The following detailed description, given by way of example and not intended to limit the exemplary embodiments solely thereto, will best be appreciated in conjunction with the accompanying drawings, in which:

FIG. 1 illustrates a schematic diagram of an optimized passenger rebooking system 100, in accordance with an exemplary embodiment of the present inventive concept.

FIG. 2 illustrates a flowchart of optimized passenger rebooking 200 by an optimized passenger rebooking program 134 of the optimized passenger rebooking system 100, in accordance with an exemplary embodiment of the present inventive concept.

FIG. 3 illustrates a block diagram depicting the hardware components included in the optimized passenger rebooking system 100 of FIG. 1, in accordance with an exemplary embodiment of the present inventive concept.

FIG. 4 illustrates a cloud computing environment, in accordance with an exemplary embodiment of the present inventive concept.

FIG. 5 illustrates abstraction model layers, in accordance with an exemplary embodiment of the present inventive concept.

It is to be understood that the included drawings are not necessarily drawn to scale/proportion. The included drawings are merely schematic examples to assist in understanding of the present inventive concept and are not intended to portray fixed parameters. In the drawings, like numbering may represent like elements.

### DETAILED DESCRIPTION OF THE DRAWINGS

Exemplary embodiments of the present inventive concept are disclosed hereafter. However, it shall be understood that the scope of the present inventive concept is not limited thereto. The disclosed exemplary embodiments are merely illustrative of the claimed system, method, and computer program product. The present inventive concept may be embodied in many different forms and should not be construed as limited to only the exemplary embodiments set forth herein. Rather, these included exemplary embodiments are provided for completeness of disclosure and to facilitate an understanding to those skilled in the art. In the detailed description, discussion of well-known features and techniques may be omitted to avoid unnecessarily obscuring the presented exemplary embodiments.

References in the specification to “one embodiment,” “an embodiment,” “an exemplary embodiment,” etc., indicate that the embodiment described may include a particular feature, structure, or characteristic, but not every embodiment may necessarily include that feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments of the present inventive concept, in the following detailed description, some processing steps or operations that are known in the art may have been combined for presentation and for illustration purposes, and in some instances, may have not been described in detail. Additionally, some processing steps or operations that are known in the art may not be described at all. The following detailed description is focused on the distinctive features or elements of the present inventive concept according to various exemplary embodiments.

As previously mentioned, despite limited success in employing overarching business rules/criteria, traditional optimized passenger rebooking systems create economic inefficiencies. They generalize the value of both available seats on alternative flights and disrupted passenger entitlement without evaluation of the opportunity costs. The present inventive concept provided herein provides for dynamic, optimized passenger rebooking by calculating passenger demand valuation (bid value) versus forecast supply valuation (bid prices) of alternative trip seats over an entire airline network of potentially hundreds of flights. This task would be otherwise impracticable to accomplish in terms of time, human resources, and money. Reduced assistance time will be dedicated to passenger trip recovery; less will be spent on traveller concessions (e.g., hotels, meals, transport vouchers, etc.); and customer, staff, and airlines generally will receive better customer satisfaction/reviews. Thus, economic inefficiencies and customer dissatisfaction associated with travel disruption related passenger rebooking is readily avoided by application of the present inventive concept.

Although the detailed description provided hereafter specifically discusses transportation providers and items of transport in terms of airlines and passengers, this is merely exemplary. The present inventive concept may apply to various contexts, transported items (e.g., goods, customers, services, data, etc.), and/or transportation providers.

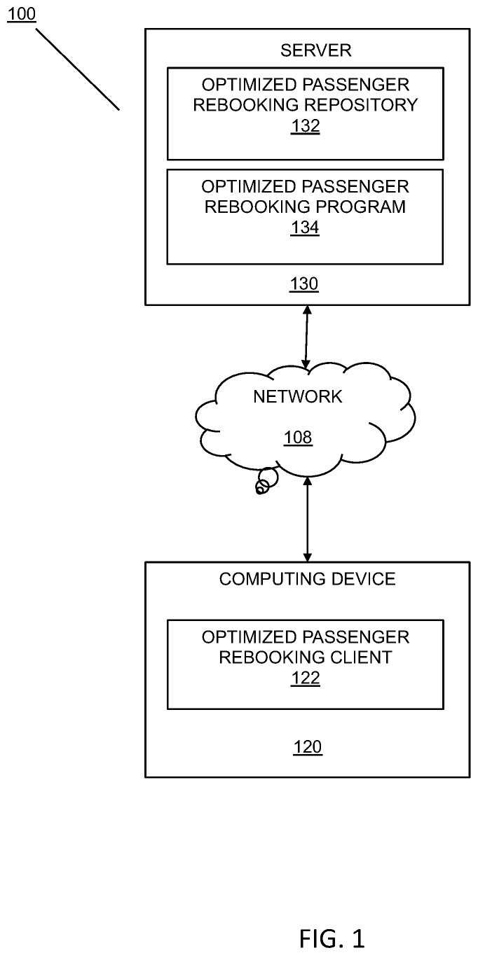

FIG. 1 depicts a schematic diagram of the optimized passenger rebooking system 100, in accordance with an exemplary embodiment of the present inventive concept.

The optimized passenger rebooking system 100 may include a computing device 120 and an optimized passenger rebooking server 130, which may be interconnected via a network 108. Programming and data content may be stored and accessed remotely across several servers via the network 108. Alternatively, programming and data may be stored locally on as few as one physical computing device 120 or stored amongst multiple computing devices.

According to the exemplary embodiment of the present inventive concept depicted in FIG. 1, the network 108 may be a communication channel capable of transferring data between connected devices. The network 108 may be the Internet, representing a worldwide collection of networks 108 and gateways to support communications between devices connected to the Internet. Moreover, the network 108 may utilize various types of connections such as wired, wireless, fiber optic, etc., which may be implemented as an intranet network, a local area network (LAN), a wide area network (WAN), or a combination thereof. The network 108 may be a Bluetooth network, a Wi-Fi network, or a combination thereof. The network 108 may operate in frequencies including 2.4 GHz and 5 GHz internet, near-field communication, Z-Wave, Zigbee, etc. The network 108 may be a telecommunications network used to facilitate telephone calls between two or more parties comprising a landline network, a wireless network, a closed network, a satellite network, or a combination thereof. In general, the network 108 may represent any combination of connections and protocols that will support communications between connected devices.

The computing device 120 may include an optimized passenger rebooking client 122, and may be an enterprise server, a laptop computer, a notebook, a tablet computer, a netbook computer, a personal computer (PC), a desktop computer, a server, a personal digital assistant (PDA), a smart phone, a mobile phone, a virtual device, a thin client, an IoT device, or any other electronic device or computing system capable of sending and receiving data to and from other computing devices. Although the computing device 120 is shown as a single device, the computing device 120 may be comprised of a cluster or plurality of computing devices, in a modular manner, etc., working together or working independently.

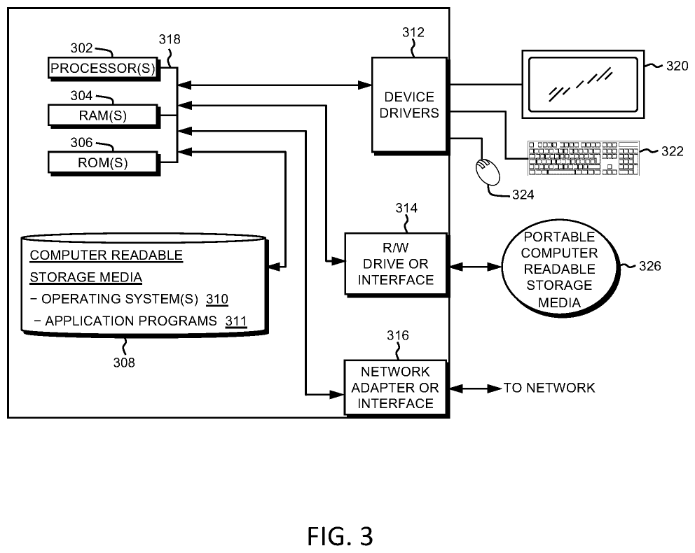

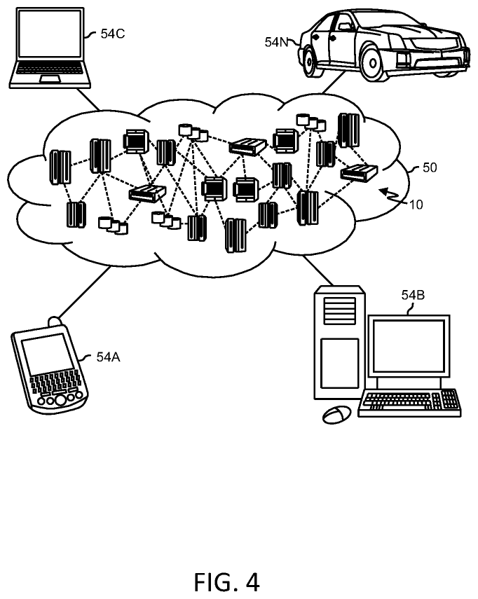

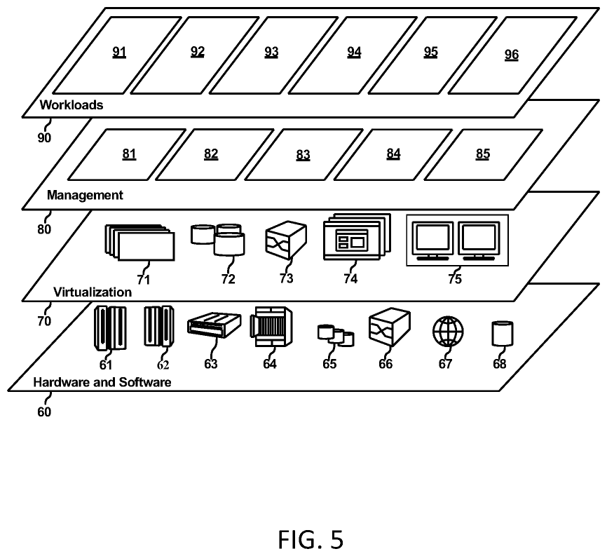

The computing device 120 is described in greater detail as a hardware implementation with reference to FIG. 3, as part of a cloud implementation with reference to FIG. 4, and/or as utilizing functional abstraction layers for processing with reference to FIG. 5.

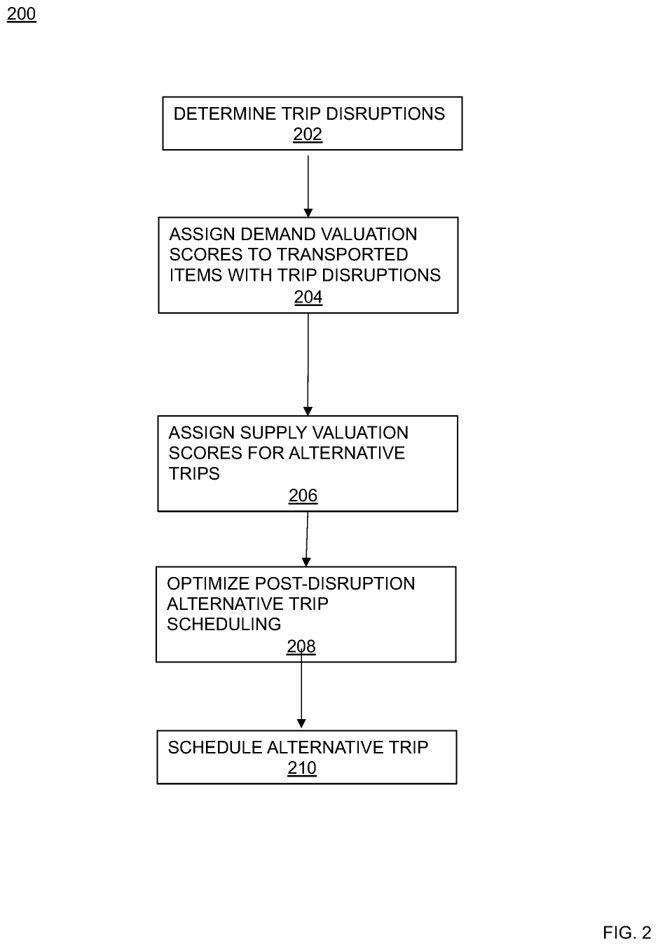

The optimized passenger rebooking client 122 may act as a client in a client-server relationship with a server, for example the optimized passenger rebooking server 130. The optimized passenger rebooking client 122 may be a software and/or a hardware application capable of communicating with and providing a user interface for a user to interact with the optimized passenger rebooking server 130 and/or other computing devices via the network 108. Moreover, the optimized passenger rebooking client 122 may be capable of transferring data between the computing device 120 and other computer devices/servers via the network 108. The optimized passenger rebooking client 122 may utilize various wired and wireless connection protocols for data transmission and exchange, including Bluetooth, 2.4 GHz and 5 GHz internet, near-field communication, etc. The optimized passenger rebooking client 122 is described in greater detail with respect to FIGS. 2-5.

The optimized passenger rebooking server 130 may include an optimized passenger rebooking repository 132 for storing various data (described hereinafter) and the optimized passenger rebooking program 134 (also described hereinafter). The optimized passenger rebooking server 130 may act as a server in a client-server relationship with a client (e.g., the optimized passenger rebooking client 122). The optimized passenger rebooking server 130 may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an IoT device, or any other electronic device or computing system capable of sending and receiving data to and from other computing devices. Although the optimized passenger rebooking server 130 is shown as a single computing device, the present inventive concept is not limited thereto. For example, the optimized passenger rebooking server 130 may be comprised of a cluster or plurality of computing devices, in a modular manner, etc., working together or working independently.

The optimized passenger rebooking server 130 is described in greater detail as a hardware implementation with reference to FIG. 3, as part of a cloud implementation with reference to FIG. 4, and/or as utilizing functional abstraction layers for processing with reference to FIG. 5. The optimized passenger rebooking program 134 and/or the optimized passenger rebooking client 122 may be software and/or hardware programs that may facilitate optimized passenger rebooking discussed in further detail with reference to FIGS. 2-5.

FIG. 2 illustrates the flowchart of the optimized passenger rebooking 200, in accordance with an exemplary embodiment of the present inventive concept. As previously mentioned, the optimized passenger rebooking system 100 described hereafter is not limited to airlines and passengers. The present inventive concept may be utilized in any environment in which the fulfilment of transported items (e.g., goods, customers, services, data, etc.) may be disrupted and require rebooking (also referred to herein as scheduling an alternative trip).

The optimized passenger rebooking program 134 may determine trip disruptions (step 202). The determined trip disruptions may be confirmed or predicted and may include delays and/or cancellations. The trip disruptions may be caused by one or more trip disruption factors which may include inclement local weather (e.g., at a departure destination, arrival destination, and/or a trip path), scheduled trip changes, server/technology maintenance/downtime, air traffic control/security issues, transit vehicle inoperability (e.g., maintenance or disrepair), operating costs versus occupancy, other trip delays in a same time frame and/or location, lack of employee coverage (e.g., pilots, drivers, etc.), etc.

Trip disruptions may be confirmed by the optimized passenger rebooking program 134 based on an imminent trip disruption, manual inputs of a user (e.g., an airline representative), and/or a detected network update (e.g., when an airline operational network server is connected to the optimized passenger rebooking server 130). The user inputs and network updates may include travel relevant multimedia (e.g., sources that are linked, uploaded, scanned, etc.) related to the one or more trip disruption factors. The user inputs and network updates may be analyzed using machine learning (e.g., natural language processing (NLP) and/or optical character recognition (OCR)). In the case of regularly updated travel relevant multimedia (e.g., hyperlinked weather forecasts), the optimized passenger rebooking program 134 may track changes to trip disruption factors in real-time. The optimized passenger rebooking program 134 may store the user inputs, network updates, and confirmed trip disruptions in the optimized passenger rebooking repository 132. The optimized passenger rebooking program 134 may analyze the user inputs, network updates, trip disruption factors, and confirmed trip disruptions to generate a predictive trip disruption model (e.g., a regression model). The optimized passenger rebooking program 134 may further analyze contextual features associated with trip disruption factor severity and/or co-occurrence (e.g., season, vehicle type, flight path, frequency of vehicle repairs, etc.). The optimized passenger rebooking program 134 may use the predictive trip disruption model to identify trips encountering similar trip disruption factors and contextual features to at least one prior confirmed trip disruption (within a predetermined threshold), and thus predict a trip disruption. Machine learning may be used to score the likelihood of a predicted trip disruption. The predicted trip disruption may be treated as a confirmed trip disruption (imminent) when a predetermined likelihood threshold is reached or upon user (e.g., an airline employee) endorsement.

The optimized passenger rebooking program 134 may analyze the accuracy of the predicted trip disruptions (e.g., whether the trip disruption was confirmed or overridden by the user) and tune the predictive trip disruption model accordingly. The optimized passenger rebooking repository 132 may store the trip disruption factors, references to travel relevant information, travel relevant multimedia, extracted features therefrom, predicted trip disruption scores/thresholds, flight route maps, and predicted trip disruption accuracy scores, etc. In an embodiment, the user and/or the optimized passenger rebooking program 134 may select predetermined weights for the trip disruption factors. The optimized passenger rebooking program 134 may determine the appropriate weights for the trip disruption factors based on machine learning, which may differ according to the presence of contextual factors. The scheduled flights subjected to the predicted trip disruption model may also be filtered according to, for example, a date(s) range, time, departure/arrival airport for scheduled flights, and/or cities/states in the flight paths of scheduled flights.

For example, an airline may be providing a scheduled flight to Boston Logan International Airport (BOS) from Chicago O'Hare International Airport (ORD) on a particular day for three different passengers. The ORD-BOS flight is a connecting stop for 2 non-direct flights from Denver International Airport (DEN) (customer #1) and San Francisco International Airport (SFO) (customer #2). For customer #3, the scheduled flight from ORD-BOS is a direct flight. The optimized passenger rebooking program 134 may apply NLP to weather forecasts in the vicinity of BOS and detect no inclement weather during the scheduled ORD-BOS flight arrival time. However, the flight path from ORD-BOS will cross areas with inclement weather and poor visibility under conditions that historically have caused delays of approximately 1 hour 80% of the time. Thus, for the purposes of optimized passenger rebooking analysis, the optimized passenger rebooking program 134 may designate the flight arriving at BOS from ORD as delayed by 1 hour. However, the inclement weather is also calculated to result in an imminent trip disruption to an earlier scheduled Chicago Midway International Airport (MDW) flight to BOS arriving at the same gate/terminal—thus the overall delay to ORD-BOS is forecast at between 1 to 2 hours.

The optimized passenger rebooking program 134 may assign demand valuation scores to transported items with trip disruptions (step 204). During a predicted or confirmed trip disruption (lasting hours, days, weeks, etc.) a “demand pool” of transported items in need of re-accommodation will continuously change. Delayed and cancelled trips add demand pressure, whereas transported items with scheduled alternative/cancelled trips remove demand pressure. The demand valuation score for a passenger may be based on at least one demand valuation factor. Demand valuation factors may be pre-selected and/or weighted. In the case of airlines and passengers, examples of demand valuation factors that might influence demand valuation may include: passenger type (e.g., disability, unaccompanied minor, special services, family with kids, joint travelers, etc.); product type (type of class/fare ticket purchased); currency tendered and overall expense (points versus money); customer type (frequent flyer program (FFP) tier, corporate/agency affiliation, VIP, social influencer (e.g., celebrity)); history of trip disruptions (e.g., prior experienced trip disruptions, length of present trip disruption); history of complaints; stage of journey at the time of trip disruption (prior, start, destination/connections, domestic/international, interline, time to scheduled arrival, elapsed trip duration, etc.); desirability of a compulsory layover area (if any); and/or exigency (how critical timely arrival is for a customer (e.g., a scheduled appointment/meeting, urgent family need, etc.). Customers may upload documentation proving the existence of an exigency to the optimized passenger rebooking program 134 which may subject the documentation to NLP. Demand valuation scores and demand valuation factors may be stored in the optimized passenger rebooking repository 132. Thus, the optimized passenger rebooking program 134 may readily generate a demand valuation model to generate individualized customer demand valuations. Demand valuation factors may be extracted for each passenger based on personally relevant multimedia (e.g., passenger inputs, past/present/future trip itineraries, network database content, customer service recorded lines, etc.) by the optimized passenger rebooking program 134 using machine learning. For each customer, the optimized passenger rebooking program 134 may learn which demand valuation factors are applicable and/or learn a hierarchy of subjective importance to the customer.

For example:

TABLE 1
DEMAND

| | Demand |
|---|---|
| Customer #1 | Score* |
| Passenger Type: Adult | 100 |
| Product: Econ, $280 | 050 |
| Journey: O&D DEN-BOS Domestic >4 hour scheduled | 125 |
| Customer: FFP none | 000 |
| + recent flight delay | 050 |
| Total Score | 325 |
| | Demand |
| Customer #2 | Score |
| Passenger Type: Adult | 100 |
| + Disability/Oxyg | 150 |
| Product: Econ, $320 | 050 |
| Journey: O&D SFO-BOS Domestic >4 hour scheduled | 125 |
| + away from home disruption | 100 |
| Customer: FFP Gold | 100 |
| + social influence | 075 |
| Total Score | 700 |
| | Demand |
| Customer #3 | Score |
| Passenger Type: Adult | 100 |
| Product: Econ, $650 | 250 |
| Journey: O&D ORD-BOS Domestic <4 hour scheduled | 075 |
| + Current journey arrival delay >4 hours | 050 |
| Customer: FFP Platinum | 200 |
| + corporate preferred | 150 |
| Total Score | 825 |

The example uses a scale of 0-1,000. The key points are; a) it provides a means of priority comparison across disrupted customers, and b) it can be used to align Demand with Supply—e.g., demand value versus supply bid price.

Customer #1 is the first customer disrupted. However, in this simplified example, they would be the lowest priority customer of the three customers for alternative trip rescheduling. Factors such as a low economy fare, non-FFP member, disrupted at home airport could all suppress their demand valuation.

Customer #2 is disrupted 3 hours later, but several factors push their demand valuation higher: possessing a disability, disruption away from home, FFP status, social influencer, etc.

Customer #3 is the last customer disrupted in this scenario, but they have several factors that raise their demand valuation: business fare/itinerary, elite FFP, corporate affiliation, etc.

While this is a simplified example, machine learning may be applied to drive deeper insight into disrupted trip characteristics and develop an engine that can more accurately prioritize the “demand pool” in a trip disruption queue, including periodic or dynamic re-prioritization.

The optimized passenger rebooking program 134 may assign supply valuation scores for capacity on alternative trips (step 206). Supply valuation scores may be determined in response to a trip disruption. Units of capacity may refer to seats, vacancies, space to accommodate transported items, etc. The supply valuation score differences between sequential capacity units (e.g., vacancies) on alternative trips may represent incremental opportunity cost and may be based on at least one supply valuation factor. The supply valuation factors may be assigned predetermined weights and may depend on a nature of the transported item. For example, in the context of airline services, the at least one supply valuation factor may include the demand valuation (general and/or specific), learned customer eligibility/preferences, market price of seats, alternative trip routing characteristics (e.g., stops, aircraft type, seat/class available), routing options (e.g., what options/how many are available for non-stop, 1-stop, 2-stop, etc.), availability (what seat capacity is available in the forecast scheduled flight and alternative flights), reliability (what is the risk that a given scheduled/alternative flight might be disrupted or taken by a competing customer with eligibility), seat desirability (e.g., window, aisle, first-class, economy, front, near bathrooms, relatively spacious, etc.), departure time, arrival time, class type, capacity to provide required accommodations, and/or amenities. Additionally, the predicted trip disruption forecast for other transit providers/airlines to the same destination(s) may affect supply valuations for seats on alternative flights. Supply valuation factors, supply valuation curves, supply valuation scores, reliability scores, customer re-accommodation success scores, and alternative flight characteristic information may be stored in the optimized passenger rebooking repository 132. The available selection of alternative trips and/or seats thereon, and consequently corresponding alternative trip valuations, may be different between customers depending on their personal demand valuation scores and eligibility/preferences.

For example, the below included table depicts potential flights for customers #1-#3, respectively:

TABLE 2
SUPPLY

| Customer #1 DEN-BOS Routing Option | Score |
|---|---|
| Fit 999 DEN-BOS 02Mar 08:15 - 12:30 | 875 |
| - low avail DEN-BOS, non-stop, early depart [symbol] high score | |
| Flt 333/444 DEN-ORD-BOS 02Mar 06:30 - 15:00 | 550 |
| - high demand ORD-BOS, morning depart [symbol] medium score | |
| Flt 666/777 DEN-IAD-BOS 02Mar 10:00 - 20:00 | 250 |
| - high avail DEN-IAD/IAD-BOS, late arrive [symbol] low score | |
| Customer #2 ORD-BOS Routing Option | Score |
| Fit 888 ORD-BOS 02Mar 09:00 - 11:50 | 800 |
| - low avall , high demand, early depart [symbol] high score | |
| Fit 444 DEN-ORD-BOS 02Mar 11:00 - 15:00 | 600 |
| - moderate avail, high demand [symbol] medium score | |
| Fit 555 ORD-BOS 02Mar 17:00 - 21:00 | 350 |
| - high avail, moderate demand, late arrive [symbol] low score | |
| Customer #3 ORD-BOS Routing Option. | Score |
| Fit 888 ORD-BOS 02Mar 09:00 - 11:50 | 800 |
| - low avail , high demand, early depart [symbol] high score | |
| Fit 444 DEN-ORD-BOS 02Mar 11:00 - 15:00 | 600 |
| - moderate avail, high demand [symbol] medium score | |
| Fit 555 ORD-BOS 02Mar 17:00 - 21:00 | 350 |
| - high avail, moderate demand, late arrive [symbol] low score | |

This simplified example illustrates supply valuation factors that may make a supply unit (e.g., seat) of network capacity more or less valuable for supply valuation purposes. The “bid price” concept gives a forecast curve of valued supply, in other words, what is the opportunity cost of using the next unit of availability. Other factors might be applied to raise or lower the supply valuation score, such as a high risk of delay/cancellation for a potential alternative trip. While this is highly simplified, the concept is to apply machine learning to drive deeper insight into network availability characteristics and develop an engine that can accurately prioritize a “supply pool” in a network disruption, including dynamic or periodic re-prioritization.

The optimized passenger rebooking program 134 may optimize passenger rebooking (step 208). Optimized passenger rebooking may be determined for at least one trip disruption. Disrupted passengers in need of alternative trips may be prioritized according to their demand valuation scores, a particular demand valuation factor(s) (e.g., unaccompanied minor, disability, etc.), and/or by how readily and closely a matching supply valuation score for a seat on an alternative flight is available. The optimized passenger rebooking program 134 may propose alternative trips to the user and/or select an optimal alternative trip. The optimized passenger rebooking program 134 may match each unit of supply with each unit of demand by seeking the smallest difference possible in corresponding demand and supply valuation scores (also referred to herein as a recovery resolution gap). In an embodiment, the match may be based on a positive difference between the demand valuation score and the supply valuation score. However, if a match with a negative difference is available with a predetermined absolute recovery gap resolution value smaller than the positive difference option, the optimized passenger rebooking program 134 may select the negative difference option. Still, the present inventive concept is not limited thereto. In an embodiment, the optimized passenger rebooking program 134 may configure alternative trip selections for disrupted passengers that cumulatively represent a 0, positive, or negative difference between overall demand valuations and overall supply valuations. In an embodiment, the demand valuation may be compared with the supply valuation curve. Demand valuations for each customer and the recovery resolution gaps for alternative flights (suggested and selected) may be stored in the optimized passenger rebooking repository 132.

For example:

TABLE 3
OPTIMIZE

| Customer #1 | |
|---|---|
| • | Low fare, at home airport, and non-FFP |
| | lower re-accommodation priority |
| • | Recovery resolution gap = 75 |
| Optimization - Conventionally, due to early | |
| disruption assignment would have been to | |
| first available high value flights. | |
| Customer #2 | |
| • | Disability, away from home and Gold status |
| | bump re-accommodation priority |
| • | Recovery resolution gap = 100 |
| Optimization - Conventionally, due to later | |
| disruption space on 444 would have been | |
| used for earlier disrupted passengers, leaving | |
| only less valuable later flights. | |
| Customer #3 | |
| • | Business fare/itinerary, platinum status and |
| | corp affiliation bump re-accommodation |
| | priority |
| • | Recovery resolution gap = 25 |

Optimization - Similarly to Customer #2, use
of availability on earlier flights would have
placed her on even later 17:00 departure.

According to an exemplary embodiment of the present inventive concept, a multi-objective model: “planned schedule as input” approach may be used.
The multi-objective network-wide optimization module may identify seat-reassignments across the network that represent an acceptable trade-off between what's the best for the airline (system optimal) versus what is best for passengers (user optimal).
System optimal: maximize expected profitability/minimize total cost of rebookings
User optimal: maximize customer satisfaction with assigned rebooking
Supply node (i, t) unit value=Sit, time periods t=1, . . . , T. (value of supply unit i at timet)
PNR (customer) j value=Vjt (value of customer j at time t), group size=nj, dj=destination (destination node of passenger j)
Assignment Value Uijt=f(Sit, Vjt)=expected utility of assigning supply (i, t) to PNR (j, t) (net value of a decision that assigns supply unit (i, t) to customer j)

The goal may be to find the highest utility stable assignments to currently open demand. In other words, maximize customer satisfaction while also limiting airline costs. This is best achieved when the matched supply and demand valuations (e.g., seat reassignments) over the network are near-perfectly aligned with the highest valued supply going to the highest valued customers, etc. This requires jointly calculating and optimizing many re-assignment decisions across the network. The optimized passenger rebooking program 134 may ensure that these matching decisions are maximally stable.

Stability Constraints: For the same origin-destination (OD), in the same rebooking window, a customer with a higher demand valuation might not be matched to a lower value supply when another customer in the same OD with a lower demand valuation is assigned a higher value supply. Due to its interconnected nature, a re-assignment decision in one part of the network can adversely impact supply availability for customers in some other part of the network. Therefore, it may not be possible within a network-wide disruption to guarantee stability for every OD given the dynamic nature of trip disruptions and the global network-level objectives. Therefore, the goal may be to calculate re-assignment decisions that yield the best tradeoff (across the network) between maximum customer satisfaction, minimum airline cost, and complete stability. Mixed-Integer Programming (MIP) optimization technology using distributed computing (hybrid cloud) infrastructure may be employed to identify these tradeoffs for large-scale disruption scenarios to produce timely reassignments and enable rapid re-optimization as the pool of unassigned customers and available demand options, and their respective valuations continually change.

Final unit demand valuation score for PNR j value at time t=Vⱼₜ
Function of original fare paid, f(t−t_{scheduled}), customer segment, etc, as explained earlier
Assignment cost of PNR j to feasible OD itinerary i=Cᵢⱼₜ consisting of the components:
   Rebooking cost: out-of-flight expenses, compensation coupons, vouchers, etc.
   Product upgrade cost: cabin upgrade, standard seat to extra-legroom, etc.
   Product downgrade (negative) cost: Aisle to middle-seat, nonstop to 1-stop, etc.
   Arrival Delay cost=f(tₐᵣᵣᵢᵥₐₗ−t_{original arrival}).
   Supply valuation score Sᵢₜ, including Volatility cost (cancellation chances etc) as mentioned earlier
INPUT Itinerary Bid Price (πᵢ) from Network Optimization Linear Program
   πᵢ=Sum of shadow prices (marginal value) of unit supply for each leg k in the itinerary i.
   Note: when PNR delay value>bid price of higher cabin class, upgrade becomes an option
Total utility (net value) of assigning PNR j to Itinerary i, Uᵢⱼₜ=Vᵢⱼₜ−Cᵢⱼₜ−πᵢ

According to an exemplary embodiment of the present inventive concept, rebooking with IROPS (irregular operations)-retiming on a time-space network may be used:
BATCH OPTIMIZATION WITH RETIMING FOR TIME HORIZON (t, T)
   Goal: Find highest value assignments and retimings among all (weakly) stable solutions
OUTPUT
   Binary decision variables xijt=1, if supply (i, t) is assigned to PNR (j), 0 otherwise.
   Binary decision variables Yik=1 if departure time k for supply i is chosen, 0 otherwise
   Using Uijt, construct sorted priority list of supply i,t for each PNR j
   Using Vit, construct sorted list of PNR for each supply i, t.
   Additional input=retiming penalty Pik for supply i, time k.
   Goal of this embodiment is to allow limited retimings of flights in order to maximize net value of seat reassignments, i.e. to maximize net value less the penalty for retiming flights. The penalty is introduced to keep the retimings to a minimum since retimings come with their own cascading network effects.
Maximize ΣᵢⱼₜUᵢⱼₜxᵢⱼₜ−ΣᵢₖPᵢₖYᵢₖ
Subject to constraints:
   Σ_{i,t}xijt=1∀j [every open PNR is assigned to a flight within time T]
   Σⱼnⱼxᵢⱼₜ<=cap(i)Yᵢₜ∀i [demand supply constraints for every supply]
   ΣₖYᵢₖ=1∀i [assign a departure time to every flight within time T]
   Σ_{j,t′>j,t}x_{ij′}+Σ_{i′>i}x_{i′j}+xᵢⱼ≥Yᵢₜ∀(i,j) [Weak stability constraints]

According to an exemplary embodiment of the present inventive concept, a greedy and Batch MIP algorithms approach may be used (Greedy may be acceptable for smaller/limited disruptions involving just a few locations. MIP approach is required for disruptions that impact multiple areas of the network):
GREEDY ASSIGNMENT (continuous procedure, at time t)
   Step 1: Pop PNR from stack (i.e. having highest Vᵢₜ) find i=argmax Uᵢⱼₜ
   Step 2: OUTPUT: Assign supply j→i
   Step 3: If needed, update bid prices π. Add new open demands to priority-stack.
   Go to step 1 if stack is non-empty, else STOP.
BATCH OPTIMIZATION FOR TIME HORIZON (t, T)
   OUTPUT Binary decision variables xij=1, if supply (i) is assigned to PNR (j)
   Using Uijt, construct sorted priority list of supply i for each PNR j
   Using Vit, construct sorted list of PNR for each supply j.
Goal: Find highest value assignments among all (weakly) stable solutions
Maximize ΣᵢⱼUᵢⱼₜxᵢⱼ
Subject to constraints:
   Σᵢ xij=1 ∀j [every open PNR is assigned to a flight within time T]
   Σⱼnⱼ xij<=cap(i)∀i [demand supply constraints for every supply]
   Σ_{j′>j}x_{ij′}+Σ_{i′>i}x_{i′j}+xᵢⱼ≥1 ∀(i, j) [Weak stability constraints]

The optimized passenger rebooking program 134 may schedule alternative trips (step 210). At least one transported item with an imminent or confirmed trip disruption may be eligible for alternative flight scheduling. The alternative flight may be scheduled automatically by the optimized passenger rebooking program 134 or by user-selection from a populated list of seats on alternative flights with a matching recovery resolution gap value. However, an authorized user (e.g., an airline employee) may override an automatically scheduled alternative trip booking. The optimized passenger rebooking program 134 may tune an optimized passenger rebooking model according to user selections and overrides. The priority of transported items for optimized passenger rebooking may be determined according to respective recovery resolution gap values. The scheduling of alternative trips may be performed at a predetermined time (e.g., after a specified period has elapsed since at least one imminent or confirmed trip disruption, upon disposition of predicted trip disruptions, etc.). If one disrupted trip has an imminent or confirmed trip cancellation/delay, but another trip to a same destination has a near imminent trip disruption as well, the alternative trip rescheduling program may await a delay/cancellation disposition of the other flight before scheduling disrupted passengers for alternative trips.

For example, customer #1 may be scheduled for Flt 666/777 DEN-IAD-BOS 02, Mar 10: 00-20:00 (recovery resolution gap: 75); customer #2 may be scheduled for Flt 444 DEN-ORD-BOS 02, Mar 11: 00-15:00 (recovery resolution gap: 100); and customer #3 may be scheduled for Flt 888 ORD-BOS 02, Mar 09: 00-11:50 (recovery resolution gap: 25).

FIG. 3 illustrates a block diagram depicting the hardware components of the optimized passenger rebooking system 100 of FIG. 1, in accordance with an exemplary embodiment of the present inventive concept.

It should be appreciated that FIG. 3 provides only an illustration of one implementation and does not imply any limitations regarding the environments in which different embodiments may be implemented. Many modifications to the depicted environment may be made.

Devices used herein may include one or more processors 302, one or more computer-readable RAMs 304, one or more computer-readable ROMs 306, one or more computer readable storage media 308, device drivers 312, read/write drive or interface 314, network adapter or interface 316, all interconnected over a communications fabric 318. Communications fabric 318 may be implemented with any architecture designed for passing data and/or control information between processors (such as microprocessors, communications and network processors, etc.), system memory, peripheral devices, and any other hardware components within a system.

One or more operating systems 310, and one or more application programs 311 are stored on one or more of the computer readable storage media 308 for execution by one or more of the processors 302 via one or more of the respective RAMs 304 (which typically include cache memory). In the illustrated embodiment, each of the computer readable storage media 308 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Devices used herein may also include a R/W drive or interface 314 to read from and write to one or more portable computer readable storage media 326. Application programs 311 on said devices may be stored on one or more of the portable computer readable storage media 326, read via the respective R/W drive or interface 314 and loaded into the respective computer readable storage media 308.

Devices used herein may also include a network adapter or interface 316, such as a TCP/IP adapter card or wireless communication adapter (such as a 4G wireless communication adapter using OFDMA technology). Application programs 311 on said computing devices may be downloaded to the computing device from an external computer or external storage device via a network (for example, the Internet, a local area network or other wide area network or wireless network) and network adapter or interface 316. From the network adapter or interface 316, the programs may be loaded onto computer readable storage media 308. The network may comprise copper wires, optical fibers, wireless transmission, routers, firewalls, switches, gateway computers and/or edge servers.

Devices used herein may also include a display screen 320, a keyboard or keypad 322, and a computer mouse or touchpad 324. Device drivers 312 interface to display screen 320 for imaging, to keyboard or keypad 322, to computer mouse or touchpad 324, and/or to display screen 320 for pressure sensing of alphanumeric character entry and user selections. The device drivers 312, R/W drive or interface 314 and network adapter or interface 316 may comprise hardware and software (stored on computer readable storage media 308 and/or ROM 306).

The programs described herein are identified based upon the application for which they are implemented in a specific one of the exemplary embodiments. However, it should be appreciated that any particular program nomenclature herein is used merely for convenience, and thus the exemplary embodiments should not be limited to use solely in any specific application identified and/or implied by such nomenclature.

It is to be understood that although this disclosure includes a detailed description on cloud computing, implementation of the teachings recited herein are not limited to a cloud computing environment. Rather, the exemplary embodiments of the present inventive concept are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

FIG. 4 illustrates a cloud computing environment, in accordance with an exemplary embodiment of the present inventive concept.

As shown, cloud computing environment 50 may include one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 40 and cloud computing environment 50 can communicate with any type of computerized device over any type of network and/or network addressable connection (e.g., using a web browser).

FIG. 5 illustrates abstraction model layers, in accordance with an exemplary embodiment of the present inventive concept.

Referring now to FIG. 5, a set of functional abstraction layers provided by cloud computing environment 50 (FIG. 4) is shown. It should be understood in advance that the components, layers, and functions shown in FIG. 5 are intended to be illustrative only and the exemplary embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfilment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and optimized passenger rebooking 96.

The exemplary embodiments of the present inventive concept may be a system, a method, and/or a computer program product at any possible technical detail level of integration. The computer program product may include a computer readable storage medium (or media) having computer readable program instructions thereon for causing a processor to carry out aspects of the present inventive concept.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present inventive concept may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present inventive concept.

Aspects of the present inventive concept are described herein with reference to flowchart illustrations and/or block diagrams of methods, apparatus (systems), and computer program products according to exemplary embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present inventive concept. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Based on the foregoing, a computer system, method, and computer program product have been disclosed. However, numerous modifications, additions, and substitutions can be made without deviating from the scope of the exemplary embodiments of the present inventive concept. Therefore, the exemplary embodiments of the present inventive concept have been disclosed by way of example and not by limitation.

1. A method for optimized passenger rebooking, the method comprising:
obtaining at least one travel disruption affecting at least one scheduled trip for a plurality of transported items;
calculating a demand valuation for each transported item of the plurality of transported items;
calculating a plurality of supply valuations for a plurality of alternative trips; and
selecting an optimized alternative trip from among the plurality of alternative trips for each transported item based on a comparison of the demand valuation and the plurality of supply valuations.

2. The method of claim 1, wherein the plurality of transported items includes a plurality of passengers,
wherein the calculating the demand valuation for each passenger of the plurality of passengers is a demand valuation score, and
wherein the demand valuation score for each passenger is based on at least one factor from among passenger type, product type, ticket value, customer type, exigency, and journey.

3. The method of claim 2, wherein the calculating the plurality of supply valuations for the plurality of alternative trips includes determining a supply valuation score for each seat on an alternative trip, and
wherein the supply valuation score is based on at least one factor from among forecast demand, alternative trip routing characteristics, routing options, availability, reliability, seat desirability, departure time, arrival time, capacity to provide required accommodations, destination location proximity, and amenities.

4. The method of claim 1, wherein a score is determined for the demand valuation for each transported item and for each supply valuation of the plurality of supply valuations, and
wherein an optimized alternative trip value for a transported item is calculated based on the smallest difference available between the transported item demand valuation score and a supply valuation score of the plurality of supply valuation scores.

5. The method of claim 4, wherein the difference between the transported item demand valuation score and the supply valuation score is a positive number.

6. The method of claim 3, wherein the selecting the alternative trip from among the plurality of alternative trips for each passenger is determined using a demand/supply curve graph, wherein each unit of demand and each unit of supply is assigned a valuation.

7. The method of claim 5, wherein a cumulative alternative trip value is determined based on the difference between a cumulative transported item demand valuation score and a corresponding cumulative supply valuation score, and
wherein alternative trips are scheduled according to the cumulative alternative trip value.

8. A computer program product for optimized passenger rebooking, the computer program product comprising:
one or more non-transitory computer-readable storage media and program instructions stored on the one or more non-transitory computer-readable storage media capable of performing a method, the method comprising:
predicting at least one travel disruption affecting at least one scheduled trip for a plurality of transported items;
calculating a demand valuation for each transported item of the plurality of transported items;
calculating a plurality of supply valuations for a plurality of alternative trips; and
selecting an optimized alternative trip from among the plurality of alternative trips for each transported item based on a comparison of the demand valuation and the plurality of supply valuations.

9. The method of claim 8, wherein the plurality of transported items includes a plurality of passengers,
wherein the calculating the demand valuation for each passenger of the plurality of passengers is a demand valuation score, and
wherein the demand valuation score for each passenger is based on at least one factor from among passenger type, product type, ticket value, customer type, exigency, and journey.

10. The method of claim 9, wherein the calculating the plurality of supply valuations for the plurality of alternative trips includes determining a supply valuation score for each seat on an alternative trip, and
wherein the supply valuation score is based on at least one factor from among forecast demand, alternative trip routing characteristics, routing options, availability, reliability, seat desirability, departure time, arrival time, capacity to provide required accommodations, destination location proximity, and amenities.

11. The method of claim 8, wherein a score is determined for the demand valuation for each transported item and for each supply valuation of the plurality of supply valuations, and
wherein an optimized alternative trip value for a transported item is calculated based on the smallest difference available between the transported item demand valuation score and a supply valuation score of the plurality of supply valuation scores.

12. The method of claim 11, wherein the difference between the transported item demand valuation score and the supply valuation score is a positive number.

13. The method of claim 10, wherein the selecting the alternative trip from among the plurality of alternative trips for each passenger is determined using a demand/supply curve graph, wherein each unit of demand and each unit of supply is assigned a valuation.

14. The method of claim 12, wherein a cumulative alternative trip value is determined based on the difference between a cumulative transported item demand valuation score and a corresponding cumulative supply valuation score, and
wherein alternative trips are scheduled according to the cumulative alternative trip value.

15. A computer system for optimized passenger rebooking, the system comprising:
one or more computer processors, one or more computer-readable storage media, and program instructions stored on the one or more of the computer-readable storage media for execution by at least one of the one or more processors capable of performing a method, the method comprising:
obtaining at least one travel disruption affecting at least one scheduled trip for a plurality of transported items;
calculating a demand valuation for each transported item of the plurality of transported items;
calculating a plurality of supply valuations for a plurality of alternative trips; and
selecting an optimized alternative trip from among the plurality of alternative trips for each transported item based on a comparison of the demand valuation and the plurality of supply valuations.

16. The method of claim 15, wherein the plurality of transported items includes a plurality of passengers,
wherein the calculating the demand valuation for each passenger of the plurality of passengers is a demand valuation score, and
wherein the demand valuation score for each passenger is based on at least one factor from among passenger type, product type, ticket value, customer type, exigency, and journey.

17. The method of claim 16, wherein the calculating the plurality of supply valuations for the plurality of alternative trips includes determining a supply valuation score for each seat on an alternative trip, and
wherein the supply valuation score is based on at least one factor from among forecast demand, alternative trip routing characteristics, routing options, availability, reliability, seat desirability, departure time, arrival time, capacity to provide required accommodations, destination location proximity, and amenities.

18. The method of claim 15, wherein a score is determined for the demand valuation for each transported item and for each supply valuation of the plurality of supply valuations, and
wherein an optimized alternative trip value for a transported item is calculated based on the smallest difference available between the transported item demand valuation score and a supply valuation score of the plurality of supply valuation scores.

19. The method of claim 18, wherein the difference between the transported item demand valuation score and the supply valuation score is a positive number.

20. The method of claim 17, wherein the selecting the alternative trip from among the plurality of alternative trips for each passenger is determined using a demand/supply curve graph, wherein each unit of demand and each unit of supply is assigned a valuation.
